(19) United States
(12) Patent Application Publication
(10) Pub. No.: US 2014/0350949 A1
(43) Pub. Date: Nov. 27, 2014

(54) MEDICATION RETRIEVAL OPTIMIZATION

(71) Applicant: CareFusion 303, Inc., San Diego, CA (US)

(72) Inventors: Thomas William UTECH, Dallas, TX (US); Maria Consolacion Jaskela, San Rafael, CA (US); William Lee Webster, Rockwall, TX (US)

(73) Assignee: CareFusion 303, Inc., San Diego, CA (US)

(21) Appl. No.: 13/900,502

(22) Filed: May 22, 2013

(51) Int. Cl. G06F 19/00

(52) U.S. Cl. CPC G06F 19/3456
USPC 705/2

(57) ABSTRACT

Systems for managing a retrieval of a prepared medication are provided. In one aspect, a system includes a memory that includes instructions, and one or more processors. The one or more processors is configured to execute the instructions to receive an identification of a plurality of unused medications and a current location of each of the plurality of unused medications, and determine an order in which to retrieve at least two of the plurality of unused medications and return the at least two of the plurality of unused medications to a return location. The one or more processors is also configured to execute the instructions to provide, for display, a listing of the at least two of the plurality of unused medications based on the order for retrieving the at least two of the plurality of unused medications. Methods and machine-readable media are also provided.

### BACKGROUND

1. Field

The present disclosure generally relates to medication distribution, and, in particular, relates to systems and methods for managing retrieval of a prepared medication in a healthcare facility.

2. Description of the Related Art

Pharmaceutical drugs can commonly be prepared to meet the needs of a patient. For instance, certain pharmaceutical drugs are compounded to fit the needs of a patient. Compounding of sterile intravenous (IV) compounds can be done in anticipation of medication orders based on standard doses, or compounding can be done specific to a patient's need based on a physician order. Compounding pharmacists combine or process appropriate ingredients using various tools to create a compounded pharmaceutical drug. Compounding may be done for medically necessary reasons, such as to change the form of the medication from a solid pill to a liquid, to avoid a non-essential ingredient that the patient is allergic to, or to obtain the exact dose(s) needed of particular active pharmaceutical ingredient(s). It may also be done for more optional reasons, such as adding flavors to a medication or otherwise altering taste or texture. Compounding is most routine in the case of intravenous (IV)/parenteral medication.

In cases of patients admitted to a healthcare facility, one or more medications to be administered to a patient are prescribed by the patient's physician. A pharmacy, generally located within the patient's hospital or healthcare facility, prepares the medication (e.g., an infusion solution) according to the physician's prescription, for example, in a cleanroom (e.g., an environment having a controlled level of contamination that is specified by a number of particles per cubic meter at a specified particle size). An appropriately trained and credentialed worker or pharmacist places the medication in a container and labels the container. The medications are then commonly staged in a pickup location, such as a bin-sorting area. A sorting person is then responsible for placing each prepared medications into bins or delivery carts that correspond to the locations where the medications will be delivered, such as an Intensive Care Unit (ICU). A delivery person retrieves the medications from the bins that correspond to areas of the healthcare facility to which that delivery person delivers. The delivery person then delivers the medications to the appropriate locations of the healthcare facility.

The medication is then delivered to the patient's location, and if the medication is an infusion solution, a clinician such as a nurse or other clinician hangs the infusion solution from a rack. The nurse connects a tube between the infusion solution and an infusion pumping system and inserts a cannula at the end of the tube into the vessel of the patient for delivery of the infusion solution to the patient.

In many instances, however, a medication for a patient may be designated as “discontinued” after the medication has been prepared but prior to the infusion being administered to the patient. For example, a patient may be discharged while a medication is en route to the patient, and thus the medication will no longer be needed for the discharged patient. In such instances, an unused medication, which could have been reused to fill a new order for another patient, may remain at the discharged patient location or another location beyond an expiration date for the medication, thus causing the medication to go to waste.

### SUMMARY

According to certain embodiments of the present disclosure, a system for managing a retrieval of a prepared medication is provided. The system includes a memory that includes instructions, and one or more processors. The one or more processors is configured to execute the instructions to receive an identification of a plurality of unused medications and a current location of each of the plurality of unused medications, and determine an order in which to retrieve at least two of the plurality of unused medications and return the at least two of the plurality of unused medications to a return location. The one or more processors is also configured to execute the instructions to provide, for display, a listing of the at least two of the plurality of unused medications based on the order for retrieving the at least two of the plurality of unused medications.

According to certain embodiments of the present disclosure, a method for managing a retrieval of a prepared medication is provided. The method includes receiving an identification of a plurality of unused medications and a current location of each of the plurality of unused medications, and determining an order in which to retrieve at least two of the plurality of unused medications and return the at least two of the plurality of unused medications to a return location. The method also includes providing, for display, a listing of the at least two of the plurality of unused medications based on the order for retrieving the at least two of the plurality of unused medications.

According to certain embodiments of the present disclosure, a machine-readable storage medium includes machine-readable instructions for causing a processor to execute a method for managing a retrieval of a prepared medication is provided. The method includes receiving an identification of a plurality of unused medications and a current location of each of the plurality of unused medications, and determining an order in which to retrieve at least two of the plurality of unused medications and return the at least two of the plurality of unused medications to a return location. The method also includes providing, for display, a listing of the at least two of the plurality of unused medications based on the order for retrieving the at least two of the plurality of unused medications.

According to certain embodiments of the present disclosure, system for managing a retrieval of a prepared medication is provided. The system includes a memory that includes instructions, and one or more processors. The one or more processors is configured to execute the instructions to receive an identification of a first medication to be delivered to a first location, and determine a route by which to deliver the first medication to the first location and retrieve at least one second medication at a second location based on the first location, the second location, and at least one of an expiration date of the first or second medication, an estimated amount of time to deliver the first medication, an estimated amount of time to retrieve the second medication, a degree of urgency associated with each of the first and second medication, a cost associated with each of the first or second medication, and an estimated distance to retrieve each of the first and second medication. The one or more processors is also configured to execute the instructions to provide, for display, the determined route.

According to certain embodiments of the present disclosure, a method for managing a retrieval of a prepared medication is provided. The method includes receiving an identification of a first medication to be delivered to a first location, and determining a route by which to deliver the first medication to the first location and retrieve at least one second medication at a second location based on the first location, the second location, and at least one of an expiration date of the first or second medication, an estimated amount of time to deliver the first medication, an estimated amount of time to retrieve the second medication, a degree of urgency associated with each of the first and second medication, a cost associated with each of the first or second medication, and an estimated distance to retrieve each of the first and second medication. The method also includes providing, for display, the determined route.

According to certain embodiments of the present disclosure, a machine-readable storage medium includes machine-readable instructions for causing a processor to execute a method for managing a retrieval of a prepared medication is provided. The method includes receiving an identification of a first medication to be delivered to a first location, and determining a route by which to deliver the first medication to the first location and retrieve at least one second medication at a second location based on the first location, the second location, and at least one of an expiration date of the first or second medication, an estimated amount of time to deliver the first medication, an estimated amount of time to retrieve the second medication, a degree of urgency associated with each of the first and second medication, a cost associated with each of the first or second medication, and an estimated distance to retrieve each of the first and second medication. The method also includes providing, for display, the determined route.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture for managing a retrieval of a prepared medication.

FIG. 2 is a block diagram illustrating an example client and server from the architecture of FIG. 1 according to certain aspects of the disclosure.

FIG. 3 illustrates an example process for managing a retrieval of a prepared medication using the server of FIG. 2.

FIG. 4 is an example illustration associated with the example process of FIG. 3.

FIG. 5 is a block diagram illustrating an example computer system with which the server of FIG. 2 can be implemented.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

The disclosed system provides a delivery person who is responsible for delivering and retrieving medications, such as infusion solutions, within a healthcare facility with a list of discontinued medications and their location in healthcare facility. The list of discontinued medications to be retrieved is ordered, for example, to identify an efficient route (e.g., based on distance, an urgency of retrieving a medication, etc.) for retrieving the discontinued medications. In certain aspects, if the delivery person is delivering medications to a particular area of the healthcare facility, then the list of discontinued medications can be ordered based on the areas to which the delivery person is delivering. The delivery person may then retrieve the discontinued medications and return them to a workroom in the pharmacy.

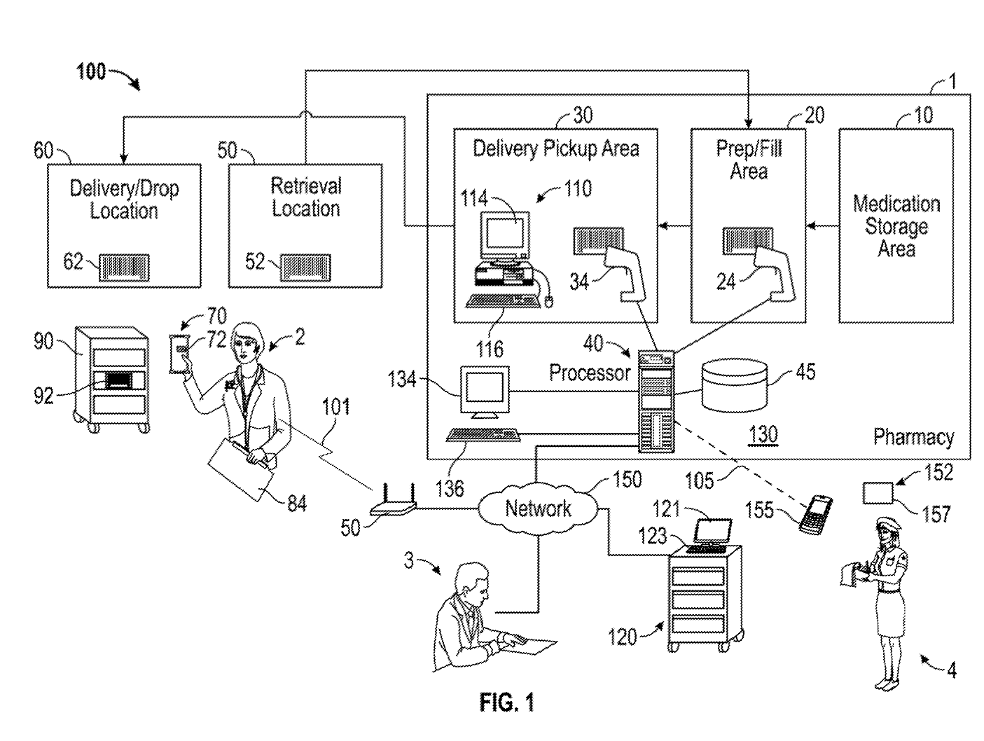

Turning now to the drawings, FIG. 1 illustrates an example architecture 100 for managing a retrieval of a prepared medication according to certain aspects of the present disclosure. For ease and clarity of illustration only, without any intent to limit the scope of the present disclosure any way, it is assumed that the prepared medication provided as an example for FIG. 1 is an anesthetic IV solution.

The architecture 100 includes a pharmacy 1 having a medication storage area 10, a fill and/or preparation (fill/prep) area 20, and a delivery pickup area 30 (e.g., bin-sorting area). The medication storage area 10 includes a plurality of unused medications and supplies including, for example, an anesthetic drug (e.g., bupivacaine or chloroprocaine) and an appropriate fluid for the anesthetic drug. The anesthetic drug and the fluid are taken from the medication storage area 10 to the prep/fill area 20 where they are mixed together to produce the anesthetic IV solution. A patient/medication ID device 72, such as a barcode label or a radio frequency identification (RFID) tag, is provided on (e.g., affixed to) a package 70 (e.g., IV bag) containing the IV solution at the prep/fill area 20. The patient/medication ID device 72 includes patient/medication ID information indicative of the medication and the patient to whom the medication is prescribed. The package 70 is then taken by a technician at the pharmacy 1 to the delivery pickup area 30. The technician determines an appropriate bin or delivery cart 90 into which to place the package 70, and then loads the package 70 onto the appropriate delivery cart 90 for delivery to a scheduled delivery drop location 60 (e.g., a patient room) by a delivery person 2. In certain aspects, the package 70 may be “discontinued” en route or after delivery to the scheduled delivery drop location 60, in which case the package 70 may be left unused at the scheduled delivery drop location 60.

In the illustrated embodiment, the prep/fill area 20 has a barcode reader 24 provided therein that the technician at the pharmacy 1 can use to read the patient/medication ID device 72 (a barcode label in the illustrated example) before the package 70 is taken to the delivery pickup area 30. The delivery pickup area 30 has a barcode reader 34 connected to a client 110 provided therein that the technician at the pharmacy 1 can use to read the patient/medication ID device 72 once the package 70 is taken to the delivery pickup area 30. The delivery cart 90 may also be provided with a location barcode label reader 92. The delivery person 2 can use the barcode reader 34 to scan the package 70 to indicate the delivery person 2 will begin delivery of the package 70.

The pharmacy 1 includes a server 130 (e.g., pharmacy server) that includes a processor 40. The server 130 is coupled to an output device 134, such as a display, and an input device 136, such as a keyboard. The server 130 can be any device having an appropriate processor, memory, and communications capability for receiving, processing, and sending information associated with a medication database 45 and prepared medications. The processor 40 is coupled to the medication database 45 that is configured to store a variety of information including order status information and delivery progress information to be discussed below. The processor 40 is configured to receive an identification of an unused package 70 (e.g., at the delivery drop location 60) and determine, based on various factors, whether the unused package 70 should be retrieved and in what order it should be retrieved. The factors can include, for example, an expiration date of the unused package 70, an estimated amount of time to retrieve the unused package 70, a degree of urgency associated with the unused package 70, a cost associated with the unused package 70, an estimated distance to retrieve the unused package 70, a likelihood of reuse of the unused package 70, or receipt of a new order for a medication that can be filled using the unused package 70.

The processor 40 is configured to determine an expiration date for the unused package 70 based on, for example, the stability and sterility of the unused package 70. Information indicative of the stability and sterility of the unused package 70 may be obtained from the medication database 45. For example, the stability of the unused package 70, which indicates a length of time a drug in the unused package 70 retains its properties without loss of potency (i.e. “shelf life”) can initially be entered by a pharmacist or other health care provider when the unused package 70 is first prepared. The sterility of the retrieved package, which indicates the conditions in which the package 70 was prepared (e.g., an environment particle count), can be determined based on a known location in which the package 70 was prepared as stored in the medication database 45. For instance, if the unused package 70 is prepared in a sterile zone, it may be given a longer expiration time frame than if the unused package 70 were not prepared in a sterile zone. The processor 40, based on a stability date entered by a pharmacist and a sterility indicator calculated based on the known location in which the package 70 was prepared, can then generate an expiration date for the unused package 70.

The processor 40 may also identify a location (e.g., retrieval location 50, such as a first patient room) of a unused package 70 that is ready for retrieval, and provide the identification of the unused package 70, the retrieval location 50, and an order in which to retrieve the unused package 70 to a client 110 for display on an output device 114 at or near the delivery pickup area 30 instructing the delivery person 2 to retrieve the unused package 70 from the retrieval location 50. The client 110 can be, for example, a computer system associated with the delivery pickup area 30 such as a desktop computer or mobile computer. The client 110 can also be, for example, a tablet computer, mobile device (e.g., a smartphone or PDA), or any other device having appropriate processor, memory, and communications capabilities. The mobile device may, for example, be associated with the delivery person 2.

The delivery location 60 and/or the retrieval location 50 can include, for example, patient rooms having an infusion device for providing an IV infusion from a package to a patient. In the illustrated example, the retrieval location 50 and the delivery location 60 are provided with location barcode label 52 and location barcode label 62, respectively. Each of the location barcode labels 52, 62 includes unique location ID information indicative of the respective location 50, 60 where the corresponding barcode label is provided. As described above, the package 70 (e.g., IV bag) containing the medication (e.g., IV solution) is provided with a patient/medication identification (ID) device 72. In the illustrated example, the patient/medication ID device 72 is a barcode label that includes patient/medication information indicative of the patient (e.g., “Jane Smith”) and the medication (e.g., “bupivacaine IV solution”). The patient/medication information may also contain other drug or patient related information such as the patient's medical conditions (e.g., allergies), name of the drug (e.g., bupivacaine), the drug dosage, the drug concentration, the drug administration schedules, and the drug administration rate.

Also depicted in the architecture 100 of FIG. 1 is a reader device 84 that is hand carried by the delivery person 2 and/or attached to the delivery cart 90 and is configured to read the patient/medication information from the patient/medication ID device 72 provided on the package 70. In the illustrated example, the reader device 84 is a barcode scanner. In those embodiments in which the barcode scanner 84 is hand carried by the delivery person 2, the scanner 84 is also configured to read the location ID information from the location barcode labels 52, 62, 92.

In the embodiments described above, the location ID devices 52, 62, 92 and/or the patient/medication ID device 72 are passive ID devices, meaning that certain action (e.g., scanning) has to be taken by the participant (e.g., a pharmacy technician or the delivery person 2 to retrieve information therefrom. In other embodiments, the ID devices can be active ID devices, meaning that the information retrieval from the ID devices occur automatically without an action taken by the participant. In some embodiments, the active ID devices can actively transmit signals containing the relevant information to the reader device 72 through a wireless link. The wireless link can use a variety of technologies including Bluetooth, ZigBee, wireless USB, and proprietary systems. In other embodiments, the active ID devices do not themselves transmit signals, but respond to query signals generated by a reader device (e.g., by altering impedance of an RF circuit therein) as the reader device passes by the ID devices in close proximity.

In the illustrated example, each time the barcode scanner 84 scans an ID device (e.g., patient/medication ID device or location ID device), the information read thereby is wirelessly transmitted to a wireless bridge 50 that receives the information. The bridge 50 is in data communication with the processor 40 via a hospital network 150. The network 150 can include, for example, any one or more of a personal area network (PAN), a local area network (LAN), a campus area network (CAN), a metropolitan area network (MAN), a wide area network (WAN), a broadband network (BBN), the Internet, and the like. Further, the network 150 can include, but is not limited to, any one or more of the following network topologies, including a bus network, a star network, a ring network, a mesh network, a star-bus network, tree or hierarchical network, and the like.

The processor 40 is configured to receive medication/patient ID information and/or location ID information read by the barcode scanner 84, generate location, use, and re-use information therefrom, and store the information in the medication database 45. The medication database 45 can include information such as, but not limited to: the patient's name or ID, the medication name or ID, the scheduled delivery location 60, the scheduled delivery time, an expiration date or time for a prepared medication, an urgency of delivery of the prepared medication, a current location of the prepared medication, an order status of the prepared medication, a return status of the prepared medication, one or more read locations where the medication/patient ID information and/or the location ID information was read by the barcode scanner 84, time when the information was read, and the name or ID of the delivery person 2.

The architecture 100 further comprises tracking devices 120, 152 that allow a care provider 4 (e.g., a nurse assigned the task of administering the patient-specific medication to the patient) to monitor the progress of the delivery of the medication. Each of the tracking devices 120, 152 is configured to receive a tracking request by the care provider 4, access the medication database 45, either directly or via the processor 40, retrieve the delivery progress information stored in the database 45, and indicate a delivery progress of the medication to the care provider 4 based on the delivery progress information. In the illustrated example, the tracking device 120 is an automated dispensing machine having a processor (not shown), a display 121, and a keyboard 123; and the tracking device 152 is a mobile communication device (e.g., a cell phone, personal digital assistant (PDA), or pager) having a processor (not shown), a display 151, and a keyboard 153. The delivery progress information can inform the care provider 4 of a last-known read location and time of the last reading. Based on such information, the care provider 4 can determine, e.g., a last-known location of an unused package 70, whether and when to retrieve the unused package 70, and an order in which to retrieve the unused package 70.

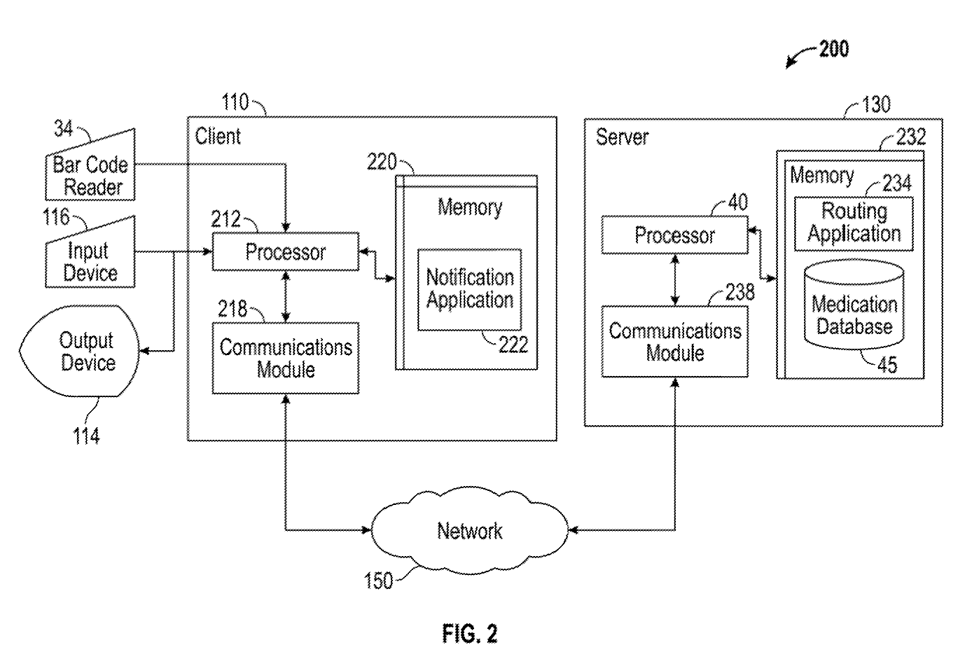

FIG. 2 is a block diagram 200 illustrating an example server 130 and client 110 in the architecture 100 of FIG. 1 according to certain aspects of the disclosure. The client 110 and the server 130 are connected over the network 150 via respective communications modules 218 and 238. The communications modules 218 and 238 are configured to interface with the network 150 to send and receive information, such as data, requests, responses, and commands to other devices on the network 150. The communications modules 218 and 238 can be, for example, modems or Ethernet cards.

The server 130 includes a processor 40, a communications module 238, and a memory 232 that includes the medication database 45 and a routing application 234. The processor 40 of the server 130 is configured to execute instructions, such as instructions physically coded into the processor 40, instructions received from software in memory 240, or a combination of both. For example, the processor 40 of the server 130 executes instructions from the routing application 234 to receive an identification of a plurality of unused medications (e.g., unused package 70) and a current location (e.g., delivery drop location 60) of each of the plurality of unused medications (e.g., in an institution, which can be one or several buildings or campuses), and determine an order in which to retrieve at least two of the unused medications and return the unused medications to a return location (e.g., delivery pickup area 30).

The determination of the order in which to retrieve the unused package 70 can be based on various factors. For example, the determination can be based on an expiration date of the unused package 70. For instance, if the unused package will not expire for several days, then the determination may indicate that the unused package 70 may be retrieved towards the end of the ordered list. The determination can also be based on an estimated amount of time to retrieve the unused package 70. For instance, if it is estimated that it will take at least 15 minutes to retrieve the unused package 70, and the unused package 70 is set to expire within an hour, then the determination may indicate that the unused package 70 should be retrieved towards the beginning of the ordered list. The determination can further be based on a degree of urgency associated with the unused package 70. For instance, if the unused package 70 is listed as being required for delivery immediately (“stat” or “photostat”), then the determination may indicate that the unused package 70 should also be retrieved immediately.

The determination can also be based on a cost associated with the unused package 70. For instance, if the unused package 70 is very expensive to produce, and the expiration date of the unused package 70 is approaching, then the determination may indicate that the unused package 70 should also be retrieved immediately. The determination can yet further be based on an estimated distance to retrieve the unused package 70. The estimated distance can be calculated, for instance, based on a current location of a client 110, such as a mobile device client 110 carries by a delivery person 2. For instance, if two unused packages are to be retrieved, and a first unused package is closer to a current location of a mobile device client 110 of a delivery person 2 than a second unused package, then the determination can indicate that the first unused package should be retrieved first.

The determination can further be based on a likelihood of reuse of the unused package 70 or receipt of a new order for a medication that can be filled using the unused package 70. For instance, if the unused package 70 is for a frequently received order or can be used to fill a new order received at the pharmacy 1, then the determination can indicate that the unused package 70 should be retrieved.

In certain aspects, the determination is indicated by associating a priority value to each of the factors discussed above. As a result, various factors can be taken into consideration when generating a sum priority value indicating a priority in which to retrieve the unused package 70. The priority value can be based on the expiration date of the unused package 70, the estimated amount of time to retrieve of the unused package 70, the degree of urgency associated with the unused package 70, the cost associated with the unused package 70, and the estimated distance to retrieve of the unused package 70. For example, if the unused package expires in the next hour, this first factor may be assigned a high priority value, and if the estimated amount of time to retrieve the unused package is thirty minutes, then this second factor may also be assigned a high priority, thereby generating an even higher sum total priority value for retrieval of the unused package 70. The order of retrieving the unused packages can be sorted according to the priority values such that, for example, an unused package 70 having a higher priority value is retrieved prior to another unused package having a lower priority value.

The processor 40 of the server 130 also executes instructions from the routing application 234 to provide, for display, a listing of the unused medications based on the determined order for retrieving the unused medications. The listing can be displayed, for example, on a client 110. This may occur where, for example, the processor 40 of the server 130 sends over the network 150 instructions to a notification application 220 in a memory 220 of the client 110, and the notification application 220 instructs the processor 212 of the client 110 to display the listing on an output device 114 of the client 110. As an unused package 70 is retrieved, a barcode 72 of the unused package 70 can be scanned using the bar code reader 34 of the client 110, and a user can confirm that the unused package 70 has been retrieved using an input device 116 of the client. In certain aspects, the displayed listing can include a route to follow within the institution in order to retrieve each unused package 70 and return them to the delivery pickup area 30. The route can be provided, for example, via text instructions or via a visualization of a map of the institution. The visualization, which may be displayed on a mobile device client 110, can be updated based on a current location of the mobile device client 110.

In certain aspects, processor 40 of the server 130 also executes instructions from the routing application 234 to receive an identification of a first medication to be delivered to a first location and determine a route by which to deliver the first medication to the first location and retrieve at least one second medication at a second location. In certain aspects, the second location may be the same as the first location. The route is determined based on the first location, the second location, and at least one of an expiration date of the first or second medication, an estimated amount of time to deliver the first medication, an estimated amount of time to retrieve the second medication, a degree of urgency associated with each of the first and second medication, a cost associated with each of the first or second medication, and an estimated distance to retrieve each of the first and second medication. The processor 40 of the server 130 can provide, for display, the route for display on the client 110, such as a visualization on a mobile device client 110.

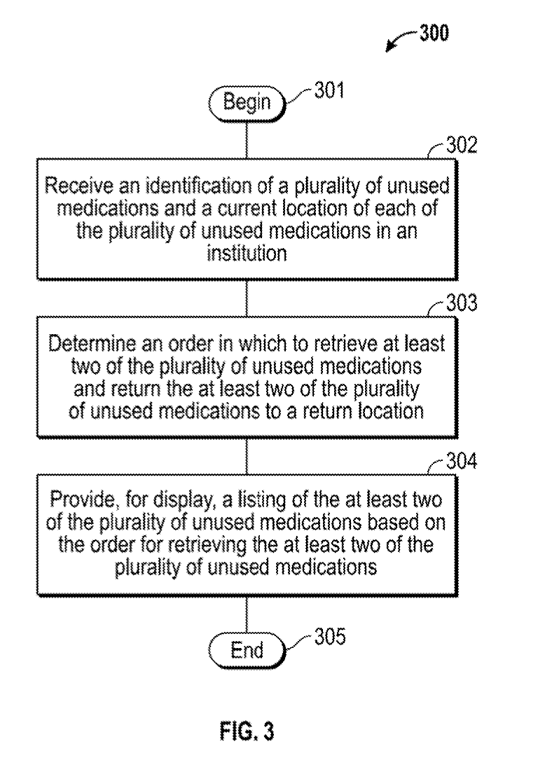

FIG. 3 illustrates an example process 300 for managing a retrieval of a prepared medication using the example server 130 of FIG. 2. While FIG. 3 is described with reference to FIG. 2, it should be noted that the process steps of FIG. 3 may be performed by other systems. The process 300 begins by proceeding from beginning step 301 to step 302 when an identification of a plurality of unused medications (e.g., unused package 70) and a current location of each of the unused medications in an institution is received, for instance, by the server 130. Next, in step 303, an order in which to retrieve at least two of the unused medications and return the retrieved unused medications to a return location (e.g., delivery pickup area 30) is determined. Finally, in step 304, a listing of the unused medications to be retrieved is provided for display, for example, on the client 110, based on the order for retrieving the unused medications. The process 300 then ends in step 305.

FIG. 3 set forth an example process 300 for managing a retrieval of a prepared medication using the example server 130 of FIG. 2. An example will now be described using the example process 300 of FIG. 3 and a client 110 that is a tablet device associated with a delivery person 2.

The process 300 begins by proceeding from beginning step 301 when a delivery person 2 logs in to the tablet device 110 to step 302 when an identification of a plurality of unused medications and a current location of each of the unused medications in an institution is received by the server 130. Next, in step 303, an order in which to retrieve four of the unused medications and return the four retrieved unused medications to a return location, the pharmacy 1, is determined. The determination is based on an expiration date of the unused medications, an estimated amount of time to retrieve the unused medications, a degree of urgency associated with the unused medications, a cost associated with the unused medications, an estimated distance to retrieve the unused medications, a likelihood of reuse of the unused medications, or receipt of a new order for a medication that can be filled using the unused medications. The determined order includes two new medications to be delivered in the institution. Finally, in step 304, a listing, based on the order for retrieving the unused medications, of the unused medications to be retrieved is provided for display on the tablet 110.

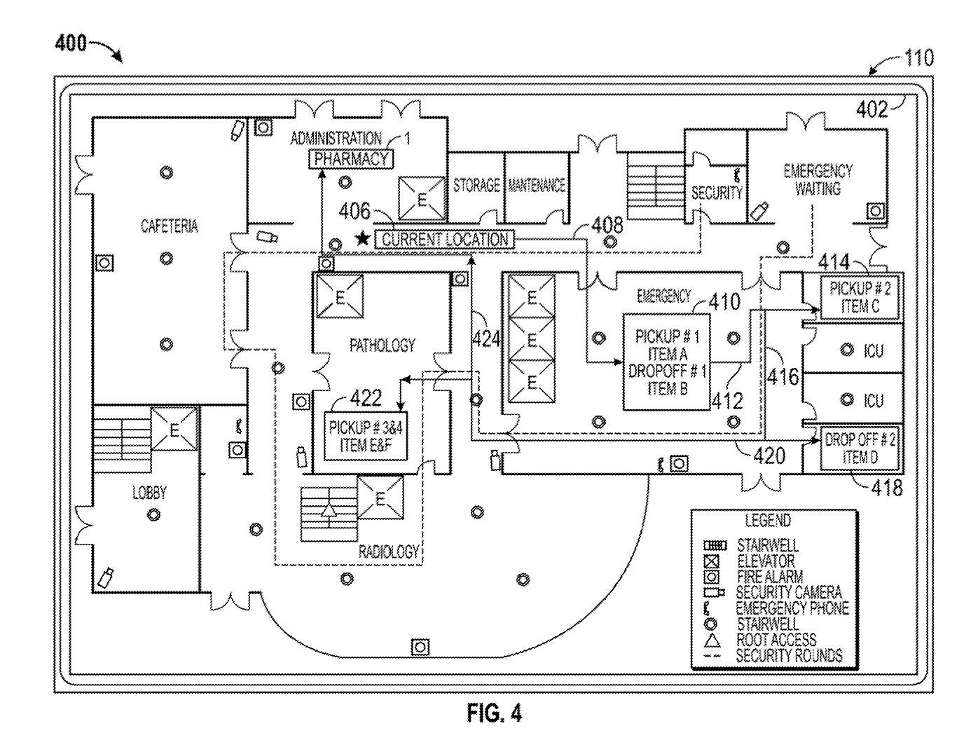

FIG. 4 provides an example illustration 400 of the tablet 110 displaying the listing of step 304. Specifically, the tablet 110 displays a visualization 402 of a route by which to retrieve the four unused medications and deliver the two new medications. The visualization indicates a current location 406 of the tablet device 110 and the route, from the current location 406, to retrieve the four unused medications and deliver the two new medications. From the current location 406, the route proceeds 408 to a first location 410 in which one medication is picked up and one medication is dropped off. Next, the route proceeds 412 to a second location 414 in which a medication is picked up. Next, the route proceeds 416 to a third location 418 in which a medication is dropped off. Next, the route proceeds 420 to a fourth location 422 in which two medications are picked up. The route then returns 424 to the pharmacy 1 so that the four retrieved unused medications can be returned. The process 300 ends in step 305.

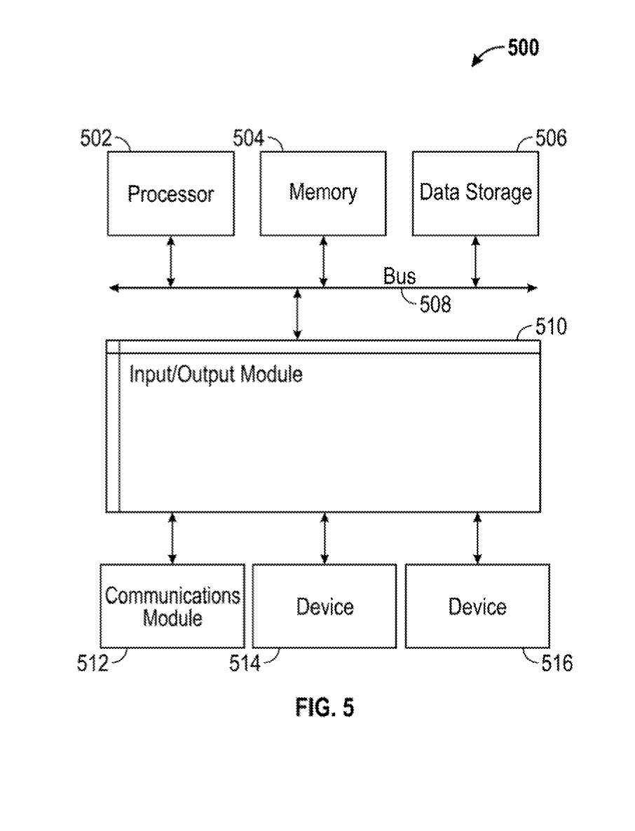

FIG. 5 is a block diagram illustrating an example computer system 50) with which the client 110 and server 130 of FIG. 2 can be implemented. In certain aspects, the computer system 500 may be implemented using hardware or a combination of software and hardware, either in a dedicated server, or integrated into another entity, or distributed across multiple entities.

Computer system 500 (e.g., client 110 and server 130) includes a bus 508 or other communication mechanism for communicating information, and a processor 502 (e.g., processor 212 and 40) coupled with bus 508 for processing information. By way of example, the computer system 500 may be implemented with one or more processors 502. Processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 500 can include, in addition to hardware, code that creates an execution environment for the computer program in question, e.g., code that constitutes processor firmware, a protocol stack, a database management system, an operating system, or a combination of one or more of them stored in an included memory 504 (e.g., memory 220 and 232), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry.

The instructions may be stored in the memory 504 and implemented in one or more computer program products, i.e., one or more modules of computer program instructions encoded on a computer readable medium for execution by, or to control the operation of, the computer system 500), and according to any method well known to those of skill in the art, including, but not limited to, computer languages such as data-oriented languages (e.g., SQL, dBase), system languages (e.g. C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, embeddable languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices (e.g., barcode reader 34). The input/output module 510 can be any input/output module. Example input/output modules 510 include data ports such as USB ports. The input/output module 510 is configured to connect to a communications module 512. Example communications modules 512 (e.g., communications module 218 and 238) include networking interface cards, such as Ethernet cards and modems. In certain aspects, the input/output module 510 is configured to connect to a plurality of devices, such as an input device 514 (e.g., input device 116) and/or an output device 516 (e.g., output device 114). Example input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device. For example, feedback provided to the user can be any form of sensory feedback, e.g. visual feedback, auditory feedback, or tactile feedback; and input from the user can be received in any form, including acoustic, speech, tactile, or brain wave input. Example output devices 516 include display devices, such as a LED (light emitting diode), CRT (cathode ray tube), or LCD (liquid crystal display) screen, for displaying information to the user.

According to one aspect of the present disclosure, the client 110 and server 130 can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in main memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network (e.g., network 150) can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computing system 500 can include clients and servers. A client and server are generally remote from each other and typically interact through a communication network. The relationship of client and server arises by virtue of computer programs running on the respective computers and having a client-server relationship to each other. Computer system 500 can be, for example, and without limitation, a desktop computer, laptop computer, or tablet computer. Computer system 500 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer readable medium” as used herein refers to any medium or media that participates in providing instructions or data to processor 502 for execution. Such a medium may take many forms, including, but not limited to, non-volatile media, volatile media, and transmission media. Non-volatile media include, for example, optical disks, magnetic disks, or flash memory, such as data storage device 506. Volatile media include dynamic memory, such as memory 504. Transmission media include coaxial cables, copper wire, and fiber optics, including the wires that comprise bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Furthermore, to the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The subject matter of this specification has been described in terms of particular aspects, but other aspects can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

These and other implementations are within the scope of the following claims.

What is claimed is:

1. A system for managing a retrieval of a prepared medication, the system comprising:
a memory comprising instructions; and
one or more processors configured to execute the instructions to:
receive an identification of a plurality of unused medications and a current location of each of the plurality of unused medications;
determine an order in which to retrieve at least two of the plurality of unused medications and return the at least two of the plurality of unused medications to a return location; and
provide, for display, a listing of the at least two of the plurality of unused medications based on the order for retrieving the at least two of the plurality of unused medications.

2. The system of claim 1, wherein the one or more processors is further configured to execute the instructions to generate, based on the order in which to retrieve the at least two of the plurality of unused medications, a route for retrieving the at least two of the plurality of unused medications from the respective current locations and returning the at least two of the plurality of unused medications to the return location.

3. The system of claim 2, wherein the one or more processors is further configured to execute the instructions to provide, for display, a visualization of the route for retrieving the at least two of the plurality of unused medications.

4. The system of claim 3, wherein the visualization is provided for display on a mobile device.

5. The system of claim 4, wherein the visualization is updated based on a current location of the mobile device.

6. The system of claim 1, wherein the determination is based on at least one of an expiration date of the at least two of the plurality of unused medications, an estimated amount of time to retrieve each of the at least two of the plurality of unused medications, a degree of urgency associated with each of the at least two of the plurality of unused medications, a cost associated with each of the at least two of the plurality of unused medications, and an estimated distance to retrieve each of the at least two of the plurality of unused medications.

7. The system of claim 6, wherein the one or more processors is further configured to execute the instructions to associate a priority value to each of the at least two of the plurality of unused medications, wherein the priority value is based on at least one of the expiration date of each of the at least two of the plurality of unused medications, the estimated amount of time to retrieve each of the at least two of the plurality of unused medications, the degree of urgency associated with each of the at least two of the plurality of unused medications, the cost associated with each of the at least two of the plurality of unused medications, and the estimated distance to retrieve each of the at least two of the plurality of unused medications.

8. The system of claim 7, wherein the order in which to retrieve at least two of the plurality of unused medications is determined according to respective priority values of each of the at least two of the plurality of unused medications.

9. The system of claim 6, wherein listing is provided for display on a mobile device, and wherein the estimated distance to retrieve each of the at least two of the plurality of unused medications is determined based on a current location of the mobile device.

10. The system of claim 1, wherein the determination is based on at least one of a likelihood of reuse of each of the at least two of the plurality of unused medications, or receipt of a new order for a medication that can be filled using at least one of the at least two of the plurality of unused medications.

11. A system for managing a retrieval of a prepared medication, the system comprising:
a memory comprising instructions; and
one or more processors configured to execute the instructions to:
receive an identification of a first medication to be delivered to a first location;
determine a route by which to deliver the first medication to the first location and retrieve at least one second medication at a second location based on the first location, the second location, and at least one of an expiration date of the first or second medication, an estimated amount of time to deliver the first medication, an estimated amount of time to retrieve the second medication, a degree of urgency associated with each of the first and second medication, a cost associated with each of the first or second medication, and an estimated distance to retrieve each of the first and second medication; and
provide, for display, the determined route.

12. A method for managing a retrieval of a prepared medication, the method comprising:
receiving an identification of a plurality of unused medications and a current location of each of the plurality of unused medications;
determining an order in which to retrieve at least two of the plurality of unused medications and return the at least two of the plurality of unused medications to a return location; and
providing, for display, a listing of the at least two of the plurality of unused medications based on the order for retrieving the at least two of the plurality of unused medications.

13. The method of claim 11, further comprising generating, based on the order in which to retrieve the at least two of the plurality of unused medications, a route for retrieving the at least two of the plurality of unused medications from the respective current locations and returning the at least two of the plurality of unused medications to the return location.

14. The method of claim 12, further comprising providing, for display, a visualization of the route for retrieving the at least two of the plurality of unused medications.

15. The method of claim 13, wherein the visualization is provided for display on a mobile device.

16. The method of claim 14, wherein the visualization is updated based on a current location of the mobile device.

17. The method of claim 11, wherein the determination is based on at least one of an expiration date of the at least two of the plurality of unused medications, an estimated amount of time to retrieve each of the at least two of the plurality of unused medications, a degree of urgency associated with each of the at least two of the plurality of unused medications, a cost associated with each of the at least two of the plurality of unused medications, and an estimated distance to retrieve each of the at least two of the plurality of unused medications.

18. The method of claim 16, further comprising associating a priority value to each of the at least two of the plurality of unused medications, wherein the priority value is based on at least one of the expiration date of each of the at least two of the plurality of unused medications, the estimated amount of time to retrieve each of the at least two of the plurality of unused medications, the degree of urgency associated with each of the at least two of the plurality of unused medications, the cost associated with each of the at least two of the plurality of unused medications, and the estimated distance to retrieve each of the at least two of the plurality of unused medications.

19. The method of claim 17, wherein the order in which to retrieve at least two of the plurality of unused medications is determined according to respective priority values of each of the at least two of the plurality of unused medications.

20. The method of claim 16, wherein listing is provided for display on a mobile device, and wherein the estimated distance to retrieve each of the at least two of the plurality of unused medications is determined based on a current location of the mobile device.

21. The method of claim 11, wherein the determination is based on at least one of a likelihood of reuse of each of the at least two of the plurality of unused medications, or receipt of a new order for a medication that can be filled using at least one of the at least two of the plurality of unused medications.

22. A method for managing a retrieval of a prepared medication, the method comprising:
receiving an identification of a first medication to be delivered to a first location;
determining a route by which to deliver the first medication to the first location and retrieve at least one second medication at a second location based on the first location, the second location, and at least one of an expiration date of the first or second medication, an estimated amount of time to deliver the first medication, an estimated amount of time to retrieve the second medication, a degree of urgency associated with each of the first and second medication, a cost associated with each of the first or second medication, and an estimated distance to retrieve each of the first and second medication; and
providing, for display, the determined route.

23. A machine-readable storage medium comprising machine-readable instructions for causing a processor to execute a method for managing a retrieval of a prepared medication, the method comprising:
receiving an identification of a plurality of unused medications and a current location of each of the plurality of unused medications;
determining an order in which to retrieve at least two of the plurality of unused medications and return the at least two of the plurality of unused medications to a return location; and
providing, for display, a listing of the at least two of the plurality of unused medications based on the order for retrieving the at least two of the plurality of unused medications.

24. A machine-readable storage medium comprising machine-readable instructions for causing a processor to execute a method for managing a retrieval of a prepared medication, the method comprising:
receiving an identification of a first medication to be delivered to a first location;
determining a route by which to deliver the first medication to the first location and retrieve at least one second medication at a second location based on the first location, the second location, and at least one of an expiration date of the first or second medication, an estimated amount of time to deliver the first medication, an estimated amount of time to retrieve the second medication, a degree of urgency associated with each of the first and second medication, a cost associated with each of the first or second medication, and an estimated distance to retrieve each of the first and second medication; and
providing, for display, the determined route.
